(19) United States
(12) Patent Application Publication
(10) Pub. No.: US 2023/0376800 A1
(43) Pub. Date: Nov. 23, 2023

(54) PREDICTING RUNTIME VARIATION IN BIG DATA ANALYTICS

(71) Applicant: Microsoft Technology Licensing, LLC, Redmond, WA (US)

(72) Inventors: Yiwen ZHU, Bellevue, WA (US); Rathijit SEN, Madison, WI (US); Robert McArn HORTON, Carte Madera, CA (US); John Mark AGOSTA, Palo Alto, CA (US)

(21) Appl. No.: 17/746,245

(22) Filed: May 17, 2022

(51) Int. Cl. G06N 5/04; G06F 9/48; G06N 5/02

(52) U.S. Cl. CPC G06N 5/04; G06F 9/4843; G06N 5/022

(57) ABSTRACT

Methods, systems and computer program products are provided for predicting runtime variation in big data analytics. Runtime probability distributions may be predicted for proposed computing jobs. A predictor may classify proposed computing jobs based on multiple runtime probability distributions that represent multiple clusters of runtime probability distributions for multiple executed recurring computing job groups. Proposed computing jobs may be classified as delta-normalized runtime probability distributions and/or a ratio-normalized runtime probability distributions. Sources of runtime variation may be identified with a quantitative contribution to predicted runtime variation. A runtime probability distribution editor may indicate modifications to sources of runtime variation in a proposed computing job and/or predict reductions in predicted runtime variation provided by modifications to a proposed computing job.

### BACKGROUND

“Big Data” refers to datasets that are too large or complex to be dealt with by traditional data-processing application software. Big Data encompasses unstructured, semi-structured and structured data, with the frequent focus on unstructured data. As of 2012, Big Data dataset “size” ranges from a few dozen terabytes to many zettabytes of data. The difficulty in processing such large amounts of data has led to the development of a set of techniques and technologies with new forms of integration to reveal insights from Big Data datasets that are diverse, complex, and of a massive scale.

Accordingly, Big Data platforms have been developed that enable scalable data processing of Big Data datasets with high efficiency, security, and usability. Cloud and serverless computing platforms may provide advantages compared to fixed resource on-premises computing systems. Cloud and serverless computing may provision resources on demand, support broad scalability, transparently and efficiently manage security and resources, and meet Service Level Objectives (SLOs) for performance and availability. The dynamic nature of resource allocation and runtime conditions on Big Data platforms may result in high variability in job runtime across multiple iterations.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

Methods, systems and computer program products are provided for predicting runtime variation in analytics related to large sets of data such as Big Data datasets. Runtime probability distributions are enabled to be predicted for proposed computing jobs by a machine learning (ML) predictor. A proposed computing job indicates a proposed execution plan and computing resources. A runtime probability distribution indicates a runtime probability distribution shape and parameters for the shape. A predictor may classify proposed computing jobs based on multiple runtime probability distributions that represent multiple clusters of runtime probability distributions for multiple executed recurring computing job groups. Proposed computing jobs may be classified (e.g., by multiple predictors) as a delta-normalized runtime probability distribution and/or a ratio-normalized runtime probability distribution. Runtime probability distributions may be complex, e.g., with multiple modes. One or more sources of runtime variation may be identified for a proposed computing job. A quantitative contribution to predicted runtime variation may be indicated for each source of runtime variation. A runtime probability distribution editor may identify (e.g., and allow selection of) one or more proposed modifications to one or more sources of runtime variation (e.g., execution plan, computing resources) and predicted reductions in the predicted runtime variation for a proposed computing job.

Further features and advantages of the subject matter (e.g., examples) disclosed herein, as well as the structure and operation of various embodiments, are described in detail below with reference to the accompanying drawings. It is noted that the present subject matter is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments of the present application and, together with the description, further serve to explain the principles of the embodiments and to enable a person skilled in the pertinent art to make and use the embodiments.

FIG. 1 shows a block diagram of an example runtime distribution prediction computing environment, according to an embodiment.

FIGS. 2A-2B show examples of clustered runtime probability distributions, according to embodiments.

FIG. 3A shows a block diagram showing an example of a classification model for a runtime distribution prediction system, according to an example embodiment.

FIGS. 3B and 3C show equation sets related to the prediction of a runtime probability distribution for a proposed computing job, according to an example embodiment.

FIG. 4 shows a flowchart of a method for predicting a runtime probability distribution for a proposed computing job, according to an example embodiment.

FIG. 5 shows a flowchart of a method for predicting a runtime probability distribution, sources of runtime variation and proposed changes for a proposed computing job, according to an example embodiment.

FIG. 6 shows a block diagram of an example computing device that may be used to implement embodiments.

The features and advantages of the examples disclosed will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The present specification and accompanying drawings disclose one or more embodiments that incorporate the features of the various examples. The scope of the present subject matter is not limited to the disclosed embodiments. The disclosed embodiments merely exemplify the various examples, and modified versions of the disclosed embodiments are also encompassed by the present subject matter. Embodiments of the present subject matter are defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to effect such feature, structure, or characteristic in connection with other embodiments whether or not explicitly described.

In the discussion, unless otherwise stated, adjectives such as “substantially” and “about” modifying a condition or relationship characteristic of a feature or features of an example embodiment of the disclosure, are understood to mean that the condition or characteristic is defined to within tolerances that are acceptable for operation of the embodiment for an application for which it is intended.

Numerous exemplary embodiments are described as follows. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

“Big Data” platforms enable scalable data processing with high efficiency, security, and usability. Cloud and serverless computing platforms may provide advantages compared to fixed resource on-premises computing systems. Cloud and serverless computing may provision resources on demand, support broad scalability, transparently and efficiently manage security and resources, and meet Service Level Objectives (SLOs) for performance and availability. However, the dynamic nature of resource allocation and runtime conditions on Big Data platforms may result in high variability in job runtime across multiple iterations, which may lead to undesirable experiences for users expecting reliable services.

Cloud service providers and customers may benefit from a capability to identify (e.g., reliably predict) sources of runtime variation and/or a capability to adjust proposed computing jobs and/or provide resources for sources of runtime variations. Identification of and/or adjustment based on runtime variations may support implementation of reliable data processing pipelines, provisioning and allocation of resources, adjustments to pricing services, satisfaction of SLOs and identification and removal (e.g., debugging) performance hazards.

The dynamic nature of resource provisioning, scheduling, and co-location with other jobs may cause occasional job slowdowns. Intrinsic properties of a job, such as parameter values and/or input data sizes, may change across iterative or repeated runs, which may lead to variations in runtime. In an example, a set of recurring jobs in a Big Data analytics platform may be submitted for execution at different frequencies. Some recurring jobs may have more stable runtimes while some recurring jobs may have occasional slowdowns with irregular patterns. The reasons why runtime variations occur, how to mitigate runtime variations, the potential for runtime variations on future execution of one-time or recurring jobs, the likelihood of a job being in a historical norm or an outlier compared to historic job runs may not be apparent.

Operators (e.g., cloud service providers) and users (e.g., customers) may prefer predictability for job pipeline executions. A better understanding of job runtime variations may enable users or user tools to generate predictable pipeline execution and/or may enable operators to reliably meet SLOs while minimizing resource provisioning costs, analyze and mitigate performance violations, and/or improve service quality. In some production systems, jobs may be scheduled or pipelined with data dependencies (e.g., jobs using output data generated by other jobs as input data). Stability and predictability of job runtimes may be important factors that affect the design and architecture of data processing pipelines. Operators may, heretofore, make little effort with respect to the stability and predictability of job runtimes due to the difficulties of assessment and/or avoidance of slowdowns. Operators may use a manual triage process based on assumptions for slowdowns due to the difficulty of capturing and understanding compounding factors that impact job runtime and stability.

Runtime variation may be empirically characterized. A runtime variation method may predict a variation or likelihood of a proposed (e.g., new or future) one-time or recurring job run being an outlier compared to the average or median runtimes of historical (e.g., already executed recurring) job runs. A machine learning model may be used to predict the slowdown in runtimes for one or more (e.g., all) workloads and/or to predict (e.g., significant) slowdowns that appear as outliers relative to historical runs. Runtime variation may be modeled, predicted, explained, and/or remedied for jobs in (e.g., Big Data) analytics systems.

Categories of runtime distributions may be predicted for enterprise analytics workloads at scale. Runtime distribution categories may be predicted for incoming (e.g., proposed, new, unexecuted) jobs, for example, with an average accuracy greater than 96%. Predictions may be performed using interpretable machine learning (ML) models trained on a large corpus of historical data. Runtime variations for executed jobs may be determined from historical (e.g., telemetry) data. Historical data may include, for example, information about job characteristics and near-real-time status of the physical clusters. In some examples, the runtime variation of millions of jobs on an exabyte-scale analytics platform may be analyzed. Factors (e.g., job runtime features) analyzed may include, for example, job plan characteristics and inputs, resource allocation, physical cluster heterogeneity and utilization, and/or scheduling policies, which may impact a system's runtime. A clustering analysis may be used to identify different runtime distributions. Some runtime distributions may have characteristic long tails.

Job runtime distribution prediction methods (e.g., using ML models) may predict runtime distributions for proposed jobs and (e.g., also) prospective (e.g., what-if) scenarios, for example, by analyzing the impact of resource allocation, scheduling, and physical cluster provisioning decisions on a job's runtime consistency and predictability. Operators and/or users may receive predicted runtime distributions, explanation of sources of runtime variance and/or proposed edits to decrease runtime variance.

A runtime distribution analysis (e.g., for prospective jobs based on historical jobs) may perform a descriptive analysis, a predictive analysis and a prescriptive analysis.

A descriptive analysis may examine historic data, which may include intrinsic job properties, resource allocation, and physical cluster conditions. A descriptive analysis may provide a better understanding of the factors affecting runtime variation for each individual job. A scalar metric, such as Coefficient of Variation (COV), may be insufficient to characterize variation with the existence of outliers. Runtime variation of (e.g., recurring) jobs may (e.g., instead) be characterized using properties of the distribution of normalized runtime of the jobs. For example, Shapley values may be used to explain predictions for variation and to quantitatively analyze the contributions of different features to the predicted variation.

A predictive analysis may be performed using an ML predictor to predict a runtime distribution for a prospective (e.g., newly-submitted) run of a (e.g., one-time or recurring) job. A predictive analysis may generate information that may be utilized by operators and/or customers, such as the probability of outliers, quantiles, and shapes of the predicted runtime distribution.

A prescriptive analysis may be performed (e.g., using an ML predictor) to quantitatively analyze alternative (e.g., what-if, potential or modified) scenarios for prospective job execution. Potential opportunities to reduce variation in job execution may be identified, for example, by limiting reliance on spare (e.g., potentially unavailable) resources, scheduling on faster (e.g., newer generations of) machines, improving load balancing across machines, modifying an execution plan, etc.

Performance modeling of computational jobs in distributed systems may be based on, for example, execution reliability, complex environmental factors, the existence of rare events, development of metrics, and/or development of labeled data.

Resource sharing in cloud computing platforms may add complexity to modeling an impact on job runtime, for example, due to noisy neighbors and other environmental changing factors. Modeling may observe the dynamic condition of each computation node and determine the potential issues that result in performance degradation.

A set (e.g., subset) of job features may be correlated (e.g., in a plot), for example, using Pearson correlation. A correlation plot may indicate the sign/direction of correlation and the magnitude of the correlation. For example, CPU variation may be positively correlated with COV. Features such as VertexCounts and DataReads may be positively correlated. A subset of (e.g., important) features may be selected from a large set of features. A complex correlation may be captured between the different factors. There may be non-linear correlations. For example, AvgRowLength and TotalDataRead may each affect the runtime distribution and its variance, although it may not be apparent from a correlation plot.

Rare events (e.g., occasional service disruption) may result in outliers and longer tails for runtime distributions. Observations of outliers for a recurring job may be collected, for example, to accurately estimate their distributions. Job instances in other job groups that have sufficient observation samples may be leveraged to learn from their distributions.

Metrics may be developed. Variation may be measured, for example, including characteristic long-tailed distributions of runtime. Extreme values of interest may be captured, and may or may not converge in a set of observations. Metrics such as COV may be used to evaluate the runtime variation. Detailed characteristics of various runtime distributions may be captured.

Runtime variation may be evaluated and predicted at the individual job level. Runtime variation is a valuable metric that customers and operators may use for automated and manual decision-making. A customized and use-case specific measurement may provide insight for monitoring and planning purposes.

Variation information, such as the probability that a job runtime may exceed an extreme value, or various quantitative properties of the runtime distributions, e.g., quantiles, may be predicted and provided to customers and/or operators.

Potential variation in runtimes may be predicted for recurring jobs, for example, rather than a prediction of absolute runtimes.

### II. Example Implementations

Methods, systems and computer program products are provided for predicting runtime variation in big data analytics. Runtime probability distributions may be predicted for proposed computing jobs by a machine learning (ML) predictor. A proposed computing job may indicate a proposed execution plan and computing resources. A runtime probability distribution may indicate a runtime probability distribution shape and parameters for the shape. A predictor may classify proposed computing jobs based on multiple runtime probability distributions that represent multiple clusters of runtime probability distributions for multiple executed recurring computing job groups. Proposed computing jobs may be classified (e.g., by multiple predictors) as a delta-normalized runtime probability distribution and/or a ratio-normalized runtime probability distribution. Runtime probability distributions may be complex, e.g., with multiple modes. One or more sources of runtime variation may be identified for a proposed computing job. A quantitative contribution to predicted runtime variation may be indicated for each source of runtime variation. A runtime probability distribution editor may identify one or more proposed modifications to one or more sources of runtime variation (e.g., execution plan, computing resources) and predicted reductions in the predicted runtime variation for a proposed computing job. Machine Learning (ML) classification may be used interchangeably with a prediction model.

In embodiments, a predictive distribution may be estimated separately, as a distinct step, from an individual sample prediction instead of estimating a predicted distribution by sampling from predicted values or directly predicting the variation. For instance, empirical distributions (e.g., clusters) may be extracted from collections of actual sample outcomes. Individual predictions may be estimated by association with the empirical distribution(s) that they are most closely related to. A cluster may be formed, for example, by splitting data (e.g., into bins) by ranges of predicted values as defined by their quantiles (or in other ways as described elsewhere herein). A predicted runtime value may be associated with a predicted distribution, which is the empirical distribution of the associated cluster. A cluster's empirical distribution may be ascribed to an individual prediction associated with (e.g., that falls within) the cluster. Note that this technique may be used to discover runtime distributions that other statistical models may be unable to discover. Furthermore, the example methodologies described herein may be applied to any statistical prediction method where clustering over actual values is possible. Knowledge of a predicted runtime distribution may provide an estimate of the risk that a job will not complete within an allotted time, which enables mitigation measures that may not otherwise be possible.

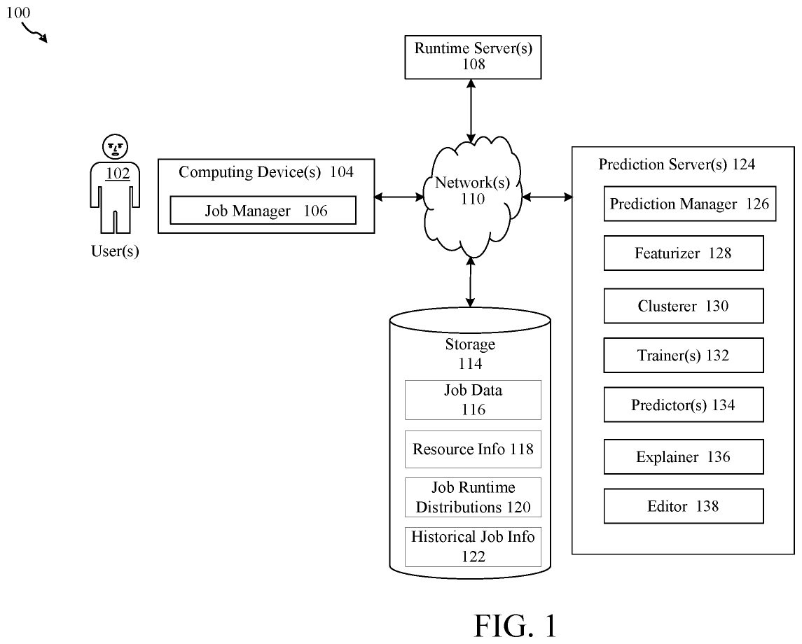

Such embodiments may be implemented in various configurations. For instance, FIG. 1 shows a block diagram of an example runtime distribution prediction computing environment (referred to herein as “prediction computing environment”) 100, according to an example embodiment. For example, sets of Big Data may be analyzed in environment 100 to determine runtime distribution predictions. Prediction computing environment 100 may include, for example, computing device(s) 104, network(s) 110, runtime server(s) 108, storage (114), and prediction server(s) 124. Example prediction computing environment 100 presents one of many possible examples of computing environments. Example prediction computing environment 100 may comprise any number of computing devices and/or servers, such as example components illustrated in FIG. 1 and other additional or alternative devices not expressly illustrated.

Network(s) 110 may include, for example, one or more of any of a local area network (LAN), a wide area network (WAN), a personal area network (PAN), a combination of communication networks, such as the Internet, and/or a virtual network. In example implementations, computing device(s) 104, runtime server(s) 108, and prediction server(s) 124 may be communicatively coupled via network(s) 110. In an implementation, any one or more of computing device(s) 104, runtime server(s) 108, and prediction server(s) 124 may communicate via one or more application programming interfaces (APIs), and/or according to other interfaces and/or techniques. Computing device(s) 104, runtime server(s) 108, and prediction server(s) 124 may include one or more network interfaces that enable communications between devices. Examples of such a network interface, wired or wireless, may include an IEEE 802.11 wireless LAN (WLAN) wireless interface, a Worldwide Interoperability for Microwave Access (Wi-MAX) interface, an Ethernet interface, a Universal Serial Bus (USB) interface, a cellular network interface, a Bluetooth™ interface, a near field communication (NFC) interface, etc. Further examples of network interfaces are described elsewhere herein.

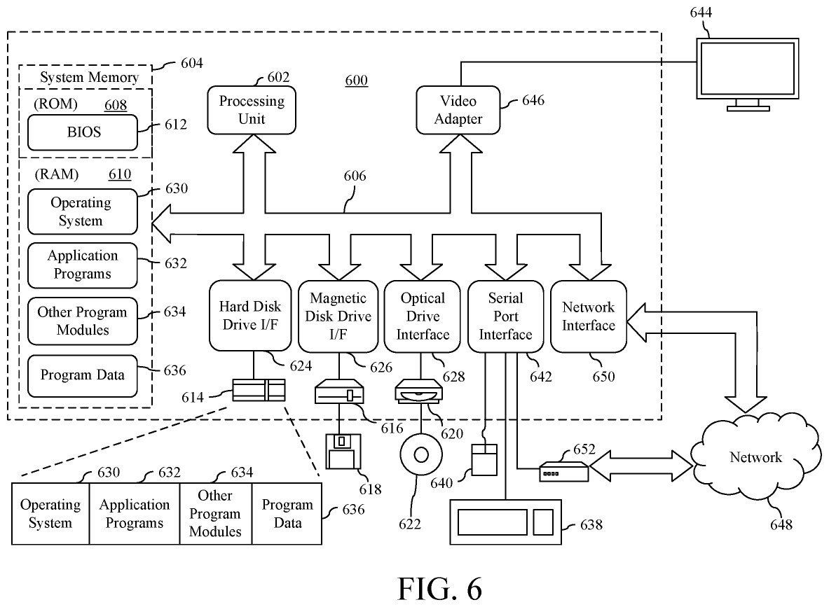

Computing device(s) 104 may comprise computing devices utilized by one or more users (e.g., individual users, family users, enterprise users, governmental users, administrators, hackers, etc.) generally referenced as user(s) 101. Computing device(s) 104 may comprise one or more applications, operating systems, virtual machines (VMs), storage devices, etc., that may be executed, hosted, and/or stored therein or via one or more other computing devices via network(s) 110. In an example, computing device(s) 104 may access one or more server devices, such as runtime server(s) 108 and prediction server(s) 124, to provide information, request one or more services (e.g., content, model(s), model training) and/or receive one or more results (e.g., trained model(s)). Computing device(s) 104 may represent any number of computing devices and any number and type of groups (e.g., various users among multiple cloud service tenants). User(s) 101 may represent any number of persons authorized to access one or more computing resources. Computing device(s) 104 may each be any type of stationary or mobile computing device, including a mobile computer or mobile computing device (e.g., a Microsoft® Surface® device, a personal digital assistant (PDA), a laptop computer, a notebook computer, a tablet computer such as an Apple iPad™, a netbook, etc.), a mobile phone, a wearable computing device, or other type of mobile device, or a stationary computing device such as a desktop computer or PC (personal computer), or a server. Computing device(s) 104 are not limited to physical machines, but may include other types of machines or nodes, such as a virtual machine, that are executed in physical machines. Computing device(s) 104 may each interface with runtime server(s) 108 and prediction server(s) 124, for example, through APIs and/or by other mechanisms. Any number of program interfaces may coexist on computing device(s) 104. An example computing device with example features is presented in FIG. 6.

Computing device(s) 104 have respective computing environments. Computing device(s) 104 may execute one or more processes in their respective computing environments. A process is any type of executable (e.g., binary, program, application) that is being executed by a computing device. A computing environment may be any computing environment (e.g., any combination of hardware, software and firmware). For example, computing device(s) 104 may execute job manager 106, which may provide a user interface (e.g., a graphical user interface (GUI)) for user(s) 102 to interact with. Job manager 106 may be configured to communicate (e.g., via network(s) 110) with one or more applications executed by prediction server(s) 124, such as prediction manager 126.

User(s) 102 may interact with job manager 106 to manage jobs. For example, user(s) 102 may use job manager 106 to develop (e.g., via a job editor) and/or to submit prospective jobs to prediction server(s) 124 for pre-execution analysis (e.g., including predictions) and/or to runtime server(s) 108 for execution. Jobs may be entered by a user and/or be generated in an SQL (Structured Query Language) or SQL-like dialect (e.g., SCOPE), which may use, for example, the C #programming language and/or user-defined functions (UDFs). A job is configured to be executed against a dataset, such as a Big Data dataset, to return a result (e.g., one or more row and/or columns of a Big Data table or other Big Data dataset).

A job (i.e., a proposed computing job) may be submitted for analysis, for example, from job manager 106 executed by computing device(s) 104 to prediction manager 126 executed by prediction server(s) 124. A job to be scheduled for execution may be submitted, for example, from job manager 106 executed by computing device(s) 104 to runtime server(s) 108, e.g., through prediction manager 126 executed by prediction server(s) 124. A submitted job may be compiled to an optimized execution plan (e.g., as a directed acyclic graph (DAG) of operators). A compiled job may be distributed across different machines (e.g., runtime server(s) 108). A (e.g., each) job may include multiple vertices (e.g., a process that may be executed on a container assigned to a physical machine).

User(s) 102 may use job manager 106 to access (e.g., view) execution information generated by runtime server(s) 108 and/or prediction information generated by prediction server(s) 124. In some examples, job manager 106 may be a Web application executed by prediction server(s) 124, in which case job manager 106 on computing device(s) 104 may represent a Web browser accessing job manager 106 executed by prediction server(s) 124.

Runtime server(s) 108 may comprise one or more computing devices, servers, services, local processes, remote machines, web services, etc. for executing jobs, which may be received via job manager 106 or prediction manager 126. In an example, runtime server(s) 108 may comprise a server located on an organization's premises and/or coupled to an organization's local network, a remotely located server, a cloud-based server (e.g., one or more servers in a distributed manner), or any other device or service that may host, manage, and/or provide resource(s) for execution service(s) for prospective (e.g., proposed) jobs. Runtime server(s) 108 may be implemented as a plurality of programs executed by one or more computing devices.

In an example, runtime server(s) 108 may comprise an exabyte-scale big data platform with hundreds of thousands of machines operating in multiple data centers worldwide. A runtime server system may use a resource manager, for example to manage hundreds of thousands or millions of system processes per day from tens of thousands of users. A runtime server system may manage efficiency, security, scalability and reliability, utilization, balancing, failures, etc.

Storage 114 may comprise one or more storage devices. Storage 114 may store data and/or programs (e.g. information). Data may be stored in storage 114 in any format, including tables. Storage 114 may comprise, for example, an in-memory data structure store. Storage 114 may represent an accumulation of storage in multiple servers. In some examples, storage 114 may store job data 116, resource information (info) 118, job runtime distributions 120, and/or historical job info 122.

Job data 116 may include, for example, data pertaining to jobs during execution, such as input data, output data, etc.

Resource information (info) 118 may include, for example, information about the near-real-time state of computing resources that may be used during execution of one or more jobs.

Job runtime distributions 120 may include, for example, one or more classes of job runtime distributions generated by clusterer 130 based on historical job info 122.

Historical job info 122 may include, for example, job information and resource information pertaining to execution of completed (e.g., historical) jobs. Historical job info 122 may be raw data, organized data, etc. For example, historical job info 122 may be organized into job groups. Organization may occur during or post storage in storage 114. For example, prediction manager 126 or clusterer 130 may organize or filter historical job info 122 that may be used by trainer(s) 132 to train predictor(s) 134.

As previously indicated, prediction of runtime distributions may be based on understanding and predicting variation in runtimes over repeated runs of jobs. Repeated job runs may be assembled into job groups. Runtime variation may refer to recurring jobs (e.g., a sample size greater than one job run). In some examples, a significant fraction (e.g., 40-60%) of jobs executed on runtime server(s) 108 may be recurring jobs. Recurrences may be identified in historical job info 122, for example, by matching on a key that combines one or more of the following: a normalized job name, which may include information, such as submission time and input dataset removed; and/or a job signature, which may have a hash value computed recursively over the DAG of operators in the compiled plan. The signature may not include job input parameters. Job groups with job instances belonging to each group may correspond to recurrences of the job. Job instances may have the same key value within each job group.

Historical job info 122 may indicate sources of runtime variation that may be useful to predict sources of runtime variation in proposed jobs. Runtimes of job instances within each job group may vary, for example, due to one or more of the following: intrinsic characteristics, resource allocation, physical cluster environment, etc.

Historical job info 122 may include, and may be grouped based on, one or more (e.g., key) intrinsic characteristics. Intrinsic characteristics may include information about a job execution plan (e.g., type of operators, estimated cardinality, dependency between operators). Other historical job info 122 may include non-intrinsic information, such as job input parameters (e.g., parameters for filter predicates) or input datasets. Different instances of jobs may have different values for non-intrinsic parameters, datasets, and their sizes, which may lead to different runtimes within the group if the parameter changes are not accompanied by a change in the compiled plan. In some example datasets, input data sizes may vary by up to a factor of 50 within the same job group.

Resource allocation may be referred to in units. For example, a unit of resource allocation may be referred to as a token, analogous to the notion of a container. The number of tokens guaranteed for a job may be specified by users at the time of job submission and/or may be recommended by the system (e.g., job manager 106, prediction manager 126). Utilization of existing resource infrastructure may be improved, for example, by repurposing unused resources as preemptive spare tokens that may be leveraged by jobs. The usage of spare tokens may be capped by the allocation specified by users. The availability of spare tokens during job runtime may be relatively unpredictable. Actual availability of spare tokens during runtime may significantly impact runtimes. In an example, a job may be allocated with 66 tokens. During a 40 minute job processing time, the number of tokens used to process the job may vary between zero and 198 tokens, e.g., including up to 132 spare tokens in addition to the 66 allocated tokens.

The maximum number of tokens used by a job during runtime may depend on how much parallelism the execution plan can exploit subject to the number of tokens allocated to the job (e.g., guaranteed and spare tokens). In some examples, the number of tokens (e.g., resources, such as servers) used during execution of various workloads by runtime server(s) 108 may vary by a factor of 10 within the same job group. There may (e.g., also) be variation in the characteristics of allocated resources. Tokens may map to computational resources on compute nodes with different stock keeping units (SKUs). In some examples, runtime servers 108 may include a cluster of servers with 10-20 different SKUs with different processing speeds. In some examples, different job instances within the same job group may simultaneously run none or more compute nodes with different SKUs.

Runtimes may vary based on a physical cluster environment, which may include the availability of spare tokens and/or the load on the individual machines. There may be significant differences in CPU utilization of machines with different SKUs in a cluster of compute nodes among runtime server(s) 108. For example, CPU utilization by SKU may vary from 2% to 33% with an average of 17% for a first SKU while varying from 10% to 100% with an average of 68% for a second SKU. Higher utilization (e.g., load) may cause more contention for shared resources. A larger range of loads may increase runtime variation.

Prediction server(s) 124 may comprise one or more computing devices, servers, services, local processes, remote machines, web services, etc. for providing runtime distribution prediction-related service(s) for prospective (e.g., proposed) jobs, which may be received from computing device(s) 104. In an example, prediction server(s) 124 may comprise a server located on an organization's premises and/or coupled to an organization's local network, a remotely located server, a cloud-based server (e.g., one or more servers in a distributed manner), or any other device or service that may host, manage, and/or provide prediction-related service(s) for prospective (e.g., proposed) jobs. Prediction server(s) 124 may be implemented as one or more (e.g., a plurality of) programs executed by one or more computing devices. Prediction server programs or components thereof may be distinguished by logic or functionality (e.g., as shown by example components in FIG. 1).

Prediction server(s) 124 may be configured to characterize and predict runtime variation based on the distribution of normalized runtimes of recurring jobs. Prediction server(s) 124 may be configured with a machine learning (ML) model. A trained ML model may include one or more components and one or more operations that take input data and return one or more predictions. Multiple components shown in prediction server(s) 124 may comprise one or more ML models.

Prediction server(s) 124 may utilize information at the job level and the machine level (e.g., job data 116, resource info 118) to generate runtime distribution predictions.

Prediction server(s) 124 may (e.g., each) include one or more job runtime distribution prediction components, such as, for example, prediction manager 126, featurizer 128, clusterer 130, trainer(s) 132, predictor(s) 134, explainer 136, and/or editor 138, which together may form one or more ML models.

Prediction manager 126 may manage, for example, one or more of user interfaces (e.g., job manager 106), job predictions, scheduling, execution, information storage (e.g., historical job info 122), collection of resource information (e.g., resource info 118), coordination of clustering, training, explaining, editing, etc.

Featurizer 128 is configured to select and process data from historical job info 122 in preparation for clustering by clusterer 130 and from a proposed job 340 (e.g., a proposed computing job received from job manager 106) for predictor(s) 134. Featurizer 128 may represent a combination of multiple data preparation (prep) components/functions, such as, for example, a data filter/selector, data loader/extractor, data preprocessor (e.g., data transformer, data normalizer), feature extractor, feature preprocessor (e.g., feature vectorizer), etc.

Featurizer 128 may extract data from historical job info 122, e.g., based on a data loader/extractor applying a data filter/selector to historical job info 122. Table 1 shows an example of datasets that featurizer 128 may selectively extract (e.g., filter) from historical job info 122, e.g., for use to generate runtime distribution distributions for the job groups. The support column may denote the minimum number of job instances per job group. The minimum number of job instances may be used to filter historical job info 122.

TABLE 1

| Dataset | Interval | Job Groups | Job Instances | Support |
|---|---|---|---|---|
| D1 | 6 months | >9 K | >3 M | 20 |
| D2 | 15 days | >11 K | >700 K | 3 |
| D3 | 5 days | >11 K | >200 K | 3 |

Featurizer 128 may extract data (e.g., data that indicates sources of runtime variation) from historical job info 122, for example, by: i) extracting information about intrinsic characteristics such as operator counts in job execution plans, input data sizes, and cardinalities, costs, etc. (e.g., estimated by a SCOPE optimizer using a Peregrine framework); ii) obtaining token usage information from job execution logs, and SKU and machine load information (e.g., using a KEA framework); and iii) joining the information together by matching the job ID, name of the machine that executes each vertex, and the corresponding job submission time.

Example datasets shown in Table 1 include a subset of jobs run over a corresponding interval. A job group is included if the number of instances per group, as indicated in the support column, exceeds a minimum threshold. In an example, 53% of jobs in historical job info 122 may have a minimum of three (3) runtime occurrences. In some examples, datasets may include batch jobs (e.g., as opposed to streaming jobs or interactive jobs). In an example, dataset D1 may be used to identify and group distributions of runtimes for jobs with a large number of occurrences (e.g., more than 20 occurrences) based on job runtime information. Dataset D2 may be used by trainer(s) 132 to train a predictor among predictor(s) 134 for runtime variation. Dataset D3 may be used to test the accuracy of a (e.g., each) predictor among predictor(s) 134.

Featurizer 128 is configured to preprocess extracted data using a data preprocessor (e.g., data transformer, data normalizer). Runtime variation may be characterized and quantified for recurring jobs. The characterization and quantification of runtime variation in historical job info 122 may form the basis for a prediction strategy.

An analysis may be performed to select features for the model. Scalar metrics, such as average, median, quantiles, and COV, alone may be insufficient to understand or predict job runtime variation. A job's median runtime may be used to characterize, predict or explain runtime variations. A job's median runtime may provide useful correlation with individual job runtimes, providing useful insight into variations across repeated runs and how long the next run of the job may take. A job's median runtime may be correlated with runtimes over different repetitions of the job. Historic job runtime median (e.g., dataset D2 in Table 1) may be plotted (e.g., in log scale) relative to job runtime. A median to specific job plot may indicate two distinct patterns: a set of points clustered along the diagonal, indicating a good correlation of individual runtimes to the median, and another set of points clustered separately in a pattern resembling a “stalagmite” hanging/extending below the diagonal set of points. The job runtimes corresponding to the points in the stalagmite may be significantly slower than the job runtimes corresponding to the points in the diagonal median runtime, contributing to a (e.g., long) tail of runtime distributions. The stalagmite may be offset from the diagonal by a fixed amount of time, which may indicate a larger relative runtime delay for faster-running jobs, or a shorter relative runtime delay for very long-running jobs. It is notable that a constant time delay looks curved in log space. The significantly longer runtimes indicated by a plotted stalagmite may be relatively rare (e.g., less than 5% of all runs), where the probability of significantly slower runs decreases with larger median values.

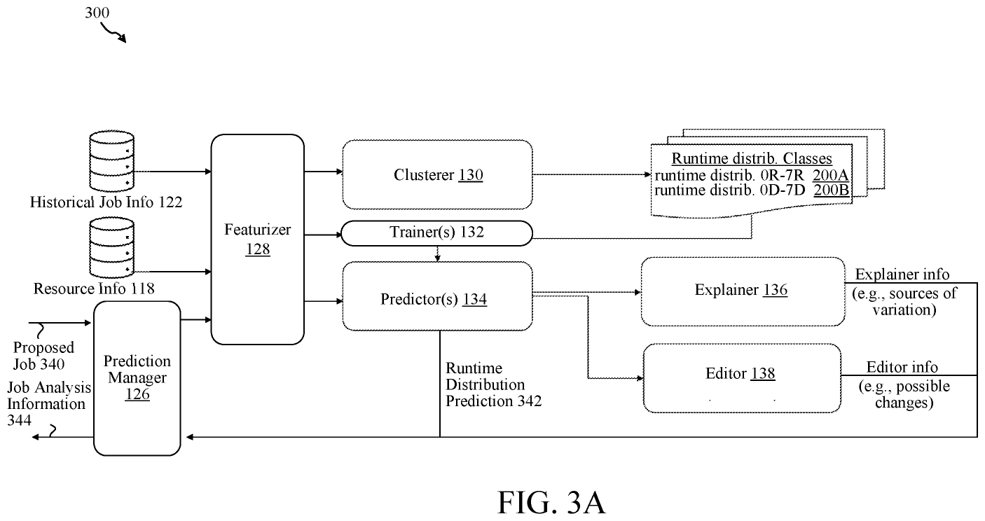

Predicting whether the runtime of a proposed job (e.g., proposed job 340 of FIG. 3A) run may fall within the median (e.g., plotted diagonal) or within outliers (e.g., a significantly longer runtime than median runtime indicated by the plotted stalagmite) may be difficult. Median runtime (e.g., even when stable and known) may be difficult to use to predict runtimes and to characterize variations because of the difficulty of predicting to which pattern a proposed job run may belong. A log scale plot of the historic average runtime versus individual runtimes and a log scale plot of the historic 95th percentile of runtimes versus individual runtimes may be similar to a log scale plot of historic median runtimes versus individual runtimes.

The Coefficient of Variation (COV) is another metric that may be used to characterize variation. A COV may be defined as a (e.g., unitless) ratio of standard deviation to the average. A COV may have limitations, such as bias, instability and lack of information. Regarding bias, example runtimes of jobs may range from seconds to days, with significant differences in average runtimes. Significant variation in runtimes may cause a COV to be biased, such that a very large COV may always be observed for short-running jobs. Regarding instability, the average runtime may increase, for example, due to the existence of outliers (e.g., in large distributed systems, some jobs may inevitably run slow). A COV may be unstable with a large number of jobs in a dataset. A COV (e.g., unlike an average) may not converge with a large sample size, which may result in an inconsistent estimator. Regarding the lack of information, a COV may be coarse-grained, lacking characteristics of a distribution, such as its shape (e.g., unimodal, bimodal, existence of outliers), which means COV may not sufficiently explain variation. A log scale plot of COV computed from historic runs for each job instance versus the COV of times from all runs in a dataset (e.g., D3 in Table 1) shows multiple groups of points (e.g., similar to medians), making it difficult to predict which group a proposed job may belong to.

Predictive features for an ML classification model may be categorized into classes and may vary among embodiments. In some examples, there may be three classes of predictive features available at compile time for a proposed job: features derived from the job's execution plan (“intrinsic” features), features representing statistics of the job's (or a similar job's) past resource use, and features describing the load in the physical cluster where the job will run. Table 3 shows an example of features including intrinsic characteristics, resource allocation, and cluster condition.

Intrinsic characteristic features may be determined based on information about a job execution plan, which may be obtained from a query optimizer at compile time as input. Intrinsic characteristics may indicate a query type, a data schema, potential computation complexity, etc. Intrinsic characteristics may include the number of operators for each type (e.g., extract, filter), estimated cardinality, etc. A newly submitted job may not indicate a detailed input data size and/or the estimated cardinality. Statistics may be extracted from historic job instances of the same job group as input features, e.g., to inform about a size of a proposed job. Extracted statistics may include, for example, total data read, temp data read, and/or statistics related to the execution plan that may be informative about the size of the proposed job. The fraction of vertices running on each SKU (e.g., associated with computational resources) may be derived as the input features. Vertices running may indicate resource consumption by each SKU. Some SKUs may process data faster than the others. Fractions of vertices executed on different SKUs may impact the runtime distribution. In an example (e.g., as shown in part by Table 3), there may be 69 intrinsic characteristic features.

Resource allocation features may (e.g., also) be extracted for historic job instances of the same job group. Resource allocation features may include, for example, resource utilization (e.g., min, max, and average token usage) and/or historic statistics (e.g., historic average and standard deviation). A historic average may be a variable for spare tokens. In an example (e.g., as shown in part by Table 3), there may be seven (7) resource allocation features.

Physical cluster environment features may be extracted. Job runtime may be affected by utilization of machines that execute its vertices. A higher utilization level may indicate a “hotter” machine may have more severe issues related to noisy neighbors and resource contention. A CPU utilization level of corresponding machines in each SKU at the job submission time may be extracted as features (e.g., model inputs). In an example (e.g., as shown in part by Table 2), there may be 22 physical cluster environment features.

Table 2 shows examples of features used in a model (e.g., for training and prediction). With reference to Table 2, “H” may represent features derived using historic data (e.g., historical job info 122). Feature derived using historic data may include, for example, historic averages (e.g., with a suffix of “Avg”) or standard deviations (with a suffix of “Std”). With reference to Table 2, “N” may represent features of a new (e.g., proposed) job. Features that can be obtained from a query optimizer may be shown as features for new jobs. Other features may be calculated, for example, based on historic observations that may be unknown at compile time (e.g., or other time) when a prediction may be made. Some of the features listed in Table 2 may not be used (e.g., directly) in a prediction model (e.g., predictor(s) 134), for example, if a feature selection step by the model removes one or more features deemed to be less indicative factors not expected to impact runtime variation.

TABLE 2
Example of features

| Category | Name | H/N | Description |
|---|---|---|---|
| Intrinsic | Temp/TotalDataReadAvg | H | Temporary/total data read of |
| characteristics | | | each job |
| | Est/InputCardinality(Avg/Std) | N/H | Estimated (input) cardinality |
| | GenXVertexCount/FracAvg | H | Average number/fraction of |
| | | | vertices executed on GenX |
| | | | (e.g., Gen3.5) |
| | VertexCountTotal(Std) | H | Total number of vertices |
| | | | (average/standard deviation) |
| | HistClusterX | H | Log-likelihood of belonging to |
| | | | ClusterX (e.g., Cluster6) using |
| | | | historic job observations |
| | Est(Exclusive)Cost(Std/Avg) | N/H | Estimated (Exclusive) cost |
| | | | (standard deviation/average |
| | | | over historic job observations) |
| | PhyOp<OperatorName>Count | N | Number of operators in the |
| | | | execution plan with |
| | | | <OperatorName>, such as |
| | | | ″Filter″ |
| | AvgRowLength(Std/Avg) | N/H | Average row length from query |
| | | | optimizer |
| | CountHistOccurences | H | Number of historic job |
| | | | observations so far |
| Resource | Max/min/avgTokensStd/Avg | H | Max/min/average token usage, |
| allocation | | | average/standard deviation over |
| | | | historic observations |
| | VirtualClusterAllocationStd | H | Token allocation specified by |
| | | | users upon submission, |
| | | | standard deviation |
| | SpareTokensStd/Avg | H | Usage of spare tokens |
| Cluster | avgGenXCPUStd/Avg | H | CPU utilization statistics |
| condition | | | (average or standard deviation) |
| | | | of GenX (e.g., Gen3.1) |
| | | | machines for historic jobs |
| | CPUUtlizationAll(Avg/Std) | N/H | CPU utilization statistics |
| | | | (average or standard deviation) |
| | | | for all machines |

Featurizer 128 may derive/generate runtime probability distributions for many different job groups based on data extracted from historical job info 122. Runtime variation for each recurring job group may be represented by a runtime probability distribution. Historical job info 122 may indicate a large variation in job runtimes. Runtimes of many different jobs may have similar probability distributions. Runtime probability distributions may be (e.g., informally) referred to as shapes. Knowledge about a job's distribution may be sufficient to determine one or more (e.g., all) characteristics about the job's variation, such as the risk that the job's runtime may exceed a (e.g., specified) threshold.

Runtime probability distributions (e.g., shapes) may be computed by normalizing job runtimes. A histogram (e.g., an empirical Probability Mass Function (PMF)) may be computed for normalized job runtimes. Jobs may be clustered based on the similarity of their runtime distributions. A prediction may be made for each proposed job about which cluster the proposed job most likely belongs to. A job's PMF may be identified as the cluster it belongs to, which may support generalization of the runtime distribution analysis across different jobs while working with a relatively small number of clusters (e.g., compared to the number of jobs). In some examples, the number of clusters may be less than 10 (e.g., eight (8) clusters), which may be understandable (e.g., distinguishable) by users.

Featurizer 128 is configured to normalize runtime data extracted from historical job info 122. One or more (e.g., two) normalization strategies (e.g., ratio normalization and delta normalization) may be used to transform job runtimes, for example, using medians computed based on historical job info 122 (e.g., Table 1, Dataset D1). Ratio-normalization may be defined as the ratio of job runtime to job historic median (e.g., job runtime/median runtime). Delta-normalization may be defined as the difference between job runtime and job historic median (e.g., job runtime−median runtime). A Ratio-normalization distribution measures relative change in runtimes. Delta-normalization distribution measures an absolute deviation from median, (e.g., measured in seconds).

Featurizer 128 may derive a histogram for the distribution of normalized runtimes for each job group. Featurizer 128 may calculate the distribution of the normalized runtime for each job group based on a bin size and range. The range may cover the majority of values with relatively fine granularity (e.g., not so small as to create fluctuation due to noise in the derived distribution). Outliers (e.g., points in the stalagmites or tails of the distributions) may be covered, for example, to allow prediction of the probability of existence of outliers for proposed jobs. Outliers may be relatively rare. Outliers may be merged into one or more bins in a distribution, for example, based on being equal to or less than (≤) or equal to or greater than (≥) selected or specified thresholds). In an example for Delta-normalization, a set of thresholds may be plus or minus 15 minutes or 900 seconds (e.g., [−900, 900]). For example, where 1% of jobs may be 1066 seconds slower than a median, the thresholds may be rounded down to 900 seconds or 15 minutes. In an example of Ratio-normalization, a set of thresholds may be, for example, a set of thresholds may be multiples of zero and 10 (e.g., [0, 10]). For example, where 1% of jobs are 10.6 times (e.g., 10.6×) slower than a median, the threshold may be rounded down to 10×. Jobs >900 s or 10× slower than a median may be defined as outliers. A bin size may be, for example, 50, 100, 200 or 500 bins. In an example, 200 bins may provide relatively smooth PMF curves and may provide different shapes of distributions that can be observed (e.g., distinguished) by users.

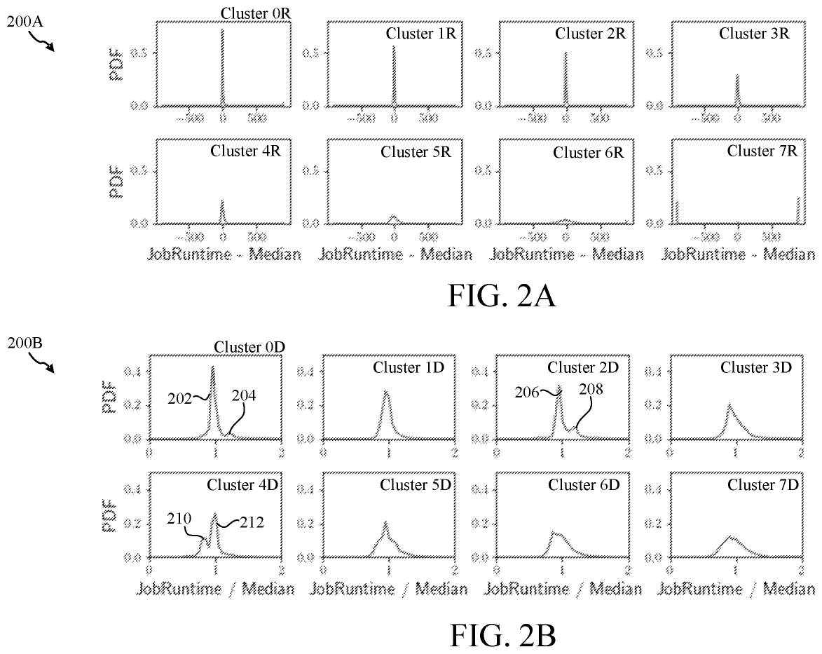

Clusterer 130 is configured to characterize (e.g., group or cluster) the historic runtime distributions derived by featurizer 128. Clusterer 130 may output, for example, one or more sets of runtime distribution classes, such as a set of runtime distribution for ratio normalization (e.g., 0R-7R shown in FIG. 2A) and a set of runtime distribution for delta normalization (e.g., 0D-7D shown in FIG. 2B). Clusterer 130 may cluster runtime distributions from historic job runs to create a set (e.g., classes) of runtime distributions for which new/proposed jobs may be classified. Clustering may support estimation of probabilities of outliers without predicting individual job runtimes directly. Prediction may associate a proposed job with a runtime distribution class that it most likely belongs to. Runtime distributions may be single mode or multimode. A set of metrics may be selected (e.g., determined, identified, defined) to depict each type of distribution (e.g., whether single mode or multimode) and to quantify the variation in numeric terms, which may be understood by user(s) 102 and operator admin (e.g., visualized in a GUI).

Clusterer 130 may be configured to perform a clustering analysis. Clusterer 130 may receive, as inputs to the clustering analysis, the PMF probabilities of each bin of each histogram representing a runtime distribution for a job group, for example, rather than the job features (e.g., input size, etc.). A clustering analysis may generate a representative (e.g., reference or “typical”) distribution shape representing multiple histograms for multiple recurring jobs (e.g., using Table 1, dataset D1). Histograms for jobs with a specified number of runtime instances (e.g., more than 20 occurrences) may be included in a clustering analysis. A greater number of instances may provide a more accurate estimation of runtime distribution. Clusterer 130 may use a machine learning (ML) algorithm (e.g., an unsupervised ML algorithm) to cluster the distributions of normalized runtimes across job groups.

Clusterer 130 may implement runtime distribution clustering based on the histogram bin size and range, a clustering algorithm, a number of clusters, and smoothing histograms.

Various implementations may utilize various types of clustering algorithms in a clustering analysis. Hierarchy clustering using a dendrogram and agglomerative clustering may be flexible, may use different distance metrics and linkage methods, and may permit users to specify the number of clusters to be formed. However, in some examples, hierarchy and agglomerative clustering may result in imbalanced clusters (e.g., an imbalance such as a single cluster with more than 90% of the job groups). In some examples, clusterer 130 may be a K-means clusterer. In some examples, K-means clustering may result in more balanced clusters.

The number of clusters may be determined, for example, based on a numerical analysis and/or a visual examination. A numerical analysis may examine a decrease of inertia, which may be defined by the sum of squared distances between each training sample and its cluster centroid. An elbow point may be selected at a point where adding more clusters does not significantly decrease the inertia. A visual examination of the clustering results may determine whether the clusters are sufficiently different from each other and have unique characteristics. In an example, eight (8) clusters may be selected (e.g., for consistency) for delta-normalization and Ratio-normalization. In other examples, the number of clusters may be higher, lower, the same or different for one or more types of normalization.

Smoothing histograms may be implemented. Clustering algorithms may be based on using PMF probabilities as input vectors without considering the correlation between each bin. In some examples, a determination may be made whether adjacent density values of bins (e.g., the probability of a runtime being in the 4th or the 5th bin) are correlated with each other. A distance measurement (e.g., dot product), may not indicate correlation between adjacent bins. A smoothing step may be implemented after deriving the PMFs to reduce the difference between any two adjacent bins, for example, so that the two smoothed vectors mentioned above may have a higher affinity. A (e.g., carefully chosen) bin size (e.g., as discussed herein) may help reduce the effect of variation due to noises and smooth a curve.

FIGS. 2A-2B illustrate examples of clustered runtime probability distributions, according to an example embodiment. FIG. 2A shows an example 200A of a set of eight clusters of ratio-normalized runtime probability distributions. The clusters are numbered cluster 0R to cluster 7R (e.g., for ratio normalization). FIG. 2B shows an example 200B of a set of eight clusters of delta-normalized runtime probability distributions (e.g., for delta normalization). The clusters are numbered cluster 0D to cluster 7D (e.g., for delta normalized). Predictor(s) 134 (e.g., a ratio-normalized predictor and/or a delta-normalized predictor) may classify proposed jobs as one of a ratio-normalized runtime distribution (e.g., one of clusters 0R-7R in FIG. 2A) and/or a delta-normalized runtime probability distribution (e.g., one of clusters 0D-7D in FIG. 2B).

FIG. 2B shows some clustered distributions have single modes and some clusters have multi-modes (e.g., some distributions have two modes). For example, as shown in FIG. 2B, delta-normalized clusters 1, 3, and 5-7 have a single mode while delta-normalized clusters 0, 2, 4 each have two modes with different variances. For example, cluster 0D shows first mode 202 and second mode 204, cluster 2D shows first mode 206 and second mode 208, and cluster 4D shows first mode 210 and second mode 212.

Table 3 shows an example summary of statistics for each cluster, including cluster identifiers (cid), percentage of job groups represented by a cid, percentage of outliers, difference between the 25th and 75th percentile runtimes and the standard deviation (std). For example, as shown by example in Table 2, ratio-normalized Cluster RO includes or represents 36.5% of the total job runs observed in the dataset. An outlier probability for ratio-normalized Cluster RO is 1.63%. An outlier may be defined as a runtime that is at least (e.g., greater than or equal to (≥)) ten times (e.g., 10×) slower than the median runtime for ratio-normalized job runtimes. The difference between 25 and 75th percentile runtimes for ratio-normalized Cluster RO is 0.06. The 95th percentile of runtimes for the ratio-normalized Cluster RO distribution is 1.41. The standard deviation for ratio-normalized Cluster RO is 2.46. The outlier probability for ratio-normalized Cluster R7 is 0.06%. Clusters may be ranked (e.g., and numbered), for example, according to an increasing difference between the 25th and 75th percentiles of normalized runtimes.

TABLE 3
Example summary of statistics for each cluster

| Ratio-normalized | | | | | | Delta-normalized | | | | | |
|---|---|---|---|---|---|---|---|---|---|---|---|
| | % | outlier | 25- | | | | % | Outlier | 25- | 95th | |
| cid | jobs | (%) | 75th | 95th | std | cid | jobs | (%) | 75th (s) | (s) | std (s) |
| R0 | 36.5 | 1.63 | 0.06 | 1.41 | 2.46 | D0 | 40.8 | 1.93 | 4 | 28 | 155 |
| R1 | 13.7 | 0.42 | 0.11 | 1.2 | 0.93 | D1 | 5.7 | 0.49 | 11 | 19 | 140 |
| R2 | 10.2 | 1.66 | 0.16 | 1.37 | 2.18 | D2 | 7.6 | 0.53% | 11 | 23 | 148 |
| R3 | 10.0 | 0.25 | 0.17 | 1.29 | 1.45 | D3 | 8.3 | 0.55 | 16 | 33 | 140 |
| R4 | 5.6 | 1.46 | 0.17 | 1.35 | 1.94 | D4 | 14.6 | 0.98 | 31 | 63 | 153 |
| R5 | 7.9 | 0.25 | 0.19 | 1.34 | 0.82 | D5 | 12.2 | 0.73 | 69 | 128 | 179 |
| R6 | 9.8 | 0.26 | 0.20 | 1.37 | 0.97 | D6 | 9.2 | 2.43 | 199 | 408 | 296 |
| R7 | 6.3 | 0.06 | 0.29 | 1.46 | 0.55 | D7 | 1.7 | 24.23 | 936 | 1359 | 2548 |

FIG. 3A illustrates a block diagram showing an example of a classification model for a runtime distribution prediction system, according to an example embodiment. Classification model 300 is shown with reference to FIGS. 1, 2A and 2B.

As shown in FIG. 3A, trainer(s) 132 is configured to develop (e.g., train) predictor(s) 134. Trainer(s) 132 may include, for example, a ratio normalized trainer (e.g., to train a ratio normalized predictor) and a delta normalized trainer (e.g., to train a delta normalized predictor). Prediction models, such as predictor(s) 134, may be used to predict which distribution of runtimes (e.g., which clustered runtime distribution class in FIG. 2A and/or FIG. 2B) a proposed job most likely belongs to, for example, based on features, such as job properties, resource allocation, and environmental conditions (e.g., system load for runtime server(s) 108. Prediction models (e.g., predictor(s) 134) may be developed (e.g., trained) by trainer(s) 132 using runtime distributions observed over a long time interval and for jobs with more recurrences, such as dataset D1 shown by example in Table 1. Trainer(s) 132 may use clustered runtime distributions generated by clusterer 130 (e.g., as shown by examples in FIGS. 2A and 2B) to train predictor(s) 134. In some examples (e.g., with reference to Table 1), trainer(s) 132 may use dataset D2 as a training set and testing may use dataset D3 as a testing set. Other implementations may select a wide variety of empirical data for training and testing.

Predictor(s) 134 represent(s) trained ML model(s) used to predict runtime distributions for proposed jobs. A prediction model may be based on (e.g., explainable) machine learning to predict the most likely shape of runtime distribution for proposed (e.g., submitted or scheduled) jobs. Predictor(s) 134 may include a ratio-normalized predictor and/or a delta-normalized predictor. For example, a ratio-normalized predictor may predict which one of multiple classes (e.g., shapes) of ratio-normalized runtime distributions shapes (e.g., clustered ratio normalized runtime distribution shapes 0R-7R shown in FIG. 2A) represents the most likely runtime distribution of a proposed job. A delta-normalized predictor may predict which one of multiple classes (e.g., shapes) of delta-normalized runtime distributions shapes (e.g., clustered delta normalized runtime distribution shapes 0D-7D shown in FIG. 2B) represents the most likely runtime distribution of a proposed job.

As shown in FIG. 3A, predictor(s) 134 is/are configured to generate runtime distribution predictions for proposed jobs. A runtime distribution prediction for a proposed job may be provided from predictor(s) 134, for example, to job manager 106 (e.g., through prediction manager 126 as job analysis information 344) for presentation (e.g., display) to user(s) 102 on a GUI displayed by computing device(s) 104. For example, as shown in FIG. 3A, a runtime distribution prediction 342 is generated by a predictor or predictor(s) 134 based on proposed job 340. Prediction manager 126 receives runtime distribution prediction 342 and provides job analysis information 344 (which includes runtime distribution prediction 342) for presentation. A presentation may include, for example, displaying information described herein to user(s) 102 and/or to an operator (e.g., admin for a cloud computing service that executes jobs).

Predictor(s) 134 is/are configured to predict the runtime distribution shape for a proposed job based on information that is available at compile time. Predictor(s) 134 may map each proposed job (e.g., a job instance) to a particular clustered runtime distribution shape class (e.g., runtime distributions shape classes labeled 0R-7R and/or 0D-7D as shown by example in FIGS. 2A and 2B).

As previously described herein, determination of clustered runtime distribution shape membership for job instances may be based on job info 122 about a set of similar job instances (e.g., in an analyzed period) within the same job group (e.g., same job name and execution plan). A job group's empirical Probability Mass Function (PMF), e.g., a histogram of the runtime distribution, may be derived. Even a small number of runtime observation supports predictions about the likelihood of job instances having one of the pre-defined distribution shapes (e.g., as shown in FIGS. 2A and 2B).

Based on Bayes' Theorem, the posterior log-likelihood that a job group with N runtime observations, xₙ=1 . . . N, belongs to a cluster zᵢ=1 . . . K may be derived based on the PMF of the N observations, ϕₕ=1 . . . H, and the PMFs of the K=8 pre-defined clusters, θ^{i=1 . . . K}_{h=1 . . . H}, for example, as described in accordance with Equations (1)-(9) of equation set 302 shown in FIG. 3B. As shown in FIG. 3B for Equations (1)-(9), the parameter H may be the number of discrete bins when the PMF is derived for each distribution. Parameter H may be a constant across (e.g., all) distributions. The parameter θ^{i=1 . . . K}_{h=1 . . . H} may represent a normalized runtime distribution for cluster i, e.g., the PMF value for bin h. The parameter ϕ_{h=1 . . . H} may represent a distribution based on observations for a particular job group, e.g., x_{n=1, 2 . . . N}), e.g., the probability for bin h of the PMF. The parameter h(xₙ) may represent the bin index that observation xₙ belongs to. The parameter nₕ may represent the number of observations of runtime (e.g., x_{i=1 . . . N}) for the job group that belongs to bin h. The parameter x_{n=1 . . . N} may represent runtime observation n, where x_{n=1 . . . N|Z}_{ᵢ}_{=1 . . . K} ˜F(θ^{i=1 . . . K}_{h=1 . . . H}). The parameter p(zᵢ) may represent prior on the probability of each cluster. The parameter p(zᵢ) may be (e.g., assumed to be) a constant across (e.g., all) clusters (e.g., non-informative prior).

Equation (9) in FIG. 3B indicates that the log-likelihood is proportional to the dot product of the vector representing the PMF of observations for a particular job group, e.g., ϕₕ, and the vector representing the PMF of the pre-defined 8 clusters (after taking the log), e.g., θⁱₕ.

In an example, log likelihood values may be determined for a comparison of a normalized runtime distribution (e.g., by Delta-normalization) for a proposed/new job (e.g., with 10 occurrences) compared to multiple clustered runtime distribution classes. A PMF for observations for the job group, e.g., ϕₕ, may be compared to the predefined clusters, θⁱₕ. A clustered runtime distribution having the highest log likelihood value (e.g., closest approximate shape) compared to the PMF for the proposed job may indicate the proposed job most probably belongs to the clustered runtime distribution. The proposed job (e.g., each job instance of the proposed job and/or the job group) may be associated with a cluster label with the highest likelihood as the prediction target (label), e.g., one of runtime distribution shape classes labeled 0R-7R and/or 0D-7D as shown by example in FIGS. 2A and 2B (e.g., based on the type of normalization applied to the features for the proposed job).

The classification model (e.g., predictor(s) 134) may, based on the inputs provided by featurizer 128, perform, for example, a passive aggressive feature selection based on feature importance (e.g., to avoid the use of correlated features. Predictor(s) 134 may perform parameter sweeping to select the best hyper-parameters for the classification algorithm, such as the number of trees for tree-based algorithms. Predictor(s) 134 may perform fitting using, for example, RandomForestClassifier, LightGBMClassifier, and/or EnsembledClassifier. One or more (e.g., a combination) of classification algorithms may be used, such as RandomForestClassifier, LightGBMClassifier, GradientBoostingClassifier, GaussianNB, and/or XGBClassifier, e.g., using soft voting. RandomForestClassifier and/or LightGBMClassifier may provide high accuracy for ML tasks using tabular data. In some examples, LightGBMClassifier may provide the highest accuracy.

One or more features may impact a prediction the most, which may (e.g., also) affect the variation. Each of multiple features may have an importance value (e.g., for a ratio-normalized prediction or a delta-normalized prediction). A Gini importance may be used to rank the features, e.g., for LightGBMClassifier based on Ratio and Delta normalization respectively. In some examples, features related to the computation complexity and input data sizes (e.g., VertexCount-Total and DataRead) may be significant (e.g., rank high in terms of importance value to the prediction). In some examples, features related to historic runtime observations may (e.g., additionally and/or alternatively) be significant (e.g., HistClusterX indicating the cluster likelihood derived using historic observations). In some examples, token utilization (e.g., MaxToken) and/or compile time information (e.g., Cardinality estimates) may (e.g., additionally and/or alternatively) be important. In some examples, CPU utilization of machines (e.g., Gen3.5CPUAvg) may (e.g., significantly) impact a prediction. As previously indicated, a physical cluster environment may affect the runtime variation of jobs. The contribution of features to runtime variation is discussed in more detail with respect to explainer 136.

A confusion matrix may be generated for predicted versus actual clusters. Separate matrices may be generated for ratio normalization and delta normalization. A confusion matrix may compare a predicted label (e.g., on the x-axis) to an actual label (e.g., on the y-axis). Each cell in the matrix may show a portion of jobs for each category. For example, the top-left cell of the matrix may indicate the portion of jobs that had a predicted label of Cluster RO or DO (e.g., based on matrix for ratio or delta normalization) and an actual label of Cluster 0. In some examples, Predictions using both ratio and delta-normalization may achieve an overall accuracy of greater than 96%.

Prediction accuracy may increase for jobs as the number of historic occurrences increases. Jobs with more historic occurrences may have a higher prediction accuracy. A prediction model may be refined, for example, by adding more observations from the same job group. In some examples, computation complexity of feature construction may be reduced while maintaining accuracy, for example, by eliminating historic observation statistics (e.g., a set of features of HistClusterX).

In some examples, the runtime distribution shapes for a (e.g., small) fraction of job groups may not fit (e.g., well) with any (e.g., fixed) clustered runtime distribution class. In some examples, one or more runtime distribution shapes may be flexible/customizable distribution shapes, which may be defined with tunable and/or continuous parameters, such as mean, variance, etc. to allow for more customized distribution shapes.

Explainer 136 is configured to explain predictions. As shown in FIG. 3A, explainer 136 may generate explainer information, which may indicate sources of variation, based on the runtime distribution prediction(s) generated by predictor(s) 134. Explainer information may be provided from explainer 136, for example, to job manager 106 (e.g., through prediction manager 126 as job analysis information) for presentation (e.g., display) to user(s) 102 on a GUI displayed by computing device(s) 104. A presentation may include, for example, displaying information described herein to user(s) 102 and/or to an operator (e.g., admin for a cloud computing service that executes jobs).

Explainer 136 may utilize feature contribution algorithms to help users and operators understand various factors associated with runtime variation. Explainer 136 may perform a descriptive analysis, for example, to help users and/or operator admin understand the job characteristics that lead to different runtime distributions. The classification model (e.g., predictor(s) 134) and/or other machine learning explanation tools may be used to understand the sources of runtime variation. Explainer 136 may, for example, quantitatively attribute runtime variation to each of multiple features.

Shapley values may explain the contribution of each “player” in a game-theoretic setting. Shapley values may be coopted/adapted to explain the contribution of features in ML models. Shapley values may explain the quantitative contribution of each feature to a prediction of runtime variation. An example method using Shapley values may randomly permute other feature values and evaluate the marginal changes of the predictions. For example, FIG. 3C shows an equation set 304 that includes Equations (10) and (11). Given a data point with observed feature values, x₁, x₂, . . . , xₚ, the Shapley value for feature j, Δj(v) in accordance with Equation (10) may be calculated as the weighted sum over the marginal changes of the prediction before and after setting the feature j to an observed value (e.g., xⱼ), while the other features may be marginalized as in Equation (11). For each randomly selected subset of features S subject to limitation j∈S, a difference may be computed between: (i) the prediction marginalized over all other features not in S, which would include xⱼ, and (ii) the prediction marginalized over all other features not in S∪j, which would not include xⱼ.

As shown in Equations (10) and (11), parameter f may represent the prediction function. Parameter v(S) may represent the prediction for feature values that are marginalized over feature values that are not included in set S.

Shapley values may be indicated, for example, in a waterfall plot showing (e.g., positive and/or negative) contributions of different features to the prediction score of a predicted cluster (e.g., for ratio or delta normalization). A baseline prediction of likelihood score may be indicated (e.g., E[f(x)]). Incremental contributions may be summed for multiple (e.g., 86) feature values with little individual contribution for a job instance. Other features with larger contributions may be individually listed, such as MaxTokenAvg, HistCluster, etc. The sum of the contributions of all features and the baseline prediction, −6.1, may be equal to the final prediction. In an example, the feature value HistCluster, which may represent the likelihood of belonging to a particular cluster class such as 0R-7R or 0D-7D with historic data, may increase the prediction score significantly, which may indicate that the HistCluster feature increases the likelihood of a job belonging to a particular cluster in the future (target value). A high positive contribution by HistCluster may indicate that past run profiles are good indicators for future runs.

Shapley values may be indicated, for example, in a plot of Shapley value (e.g., impact on model output) versus Shapley values for features. A Shapley value distribution may be shown for a (e.g., each) particular cluster prediction with ratio and/or delta-normalization. For example, the top 20 most important features may be ranked by the mean of absolute Shapley values. The distribution of Shapley values may be shown along the x-axis for each corresponding feature. In an example, a TotalDataReadAvg feature may indicate that jobs with a higher value of TotalDataReadAvg tend to have higher Shapley values, which leads to a higher likelihood of being in a predicted cluster. In some examples, jobs with large input size (e.g., TotalDataReadAvg, TotalDataRead-Std) and/or small AvgTokensAvg with large MaxTokensAvg may have higher Shapley score contributions to the prediction of a particular cluster, indicating that jobs with one or more of these characteristics may be more likely to be in a predicted cluster.

A distribution of Shapley values with respect to each individual feature may be plotted, where each dot may correspond to one job instance. In some examples, jobs with large TotalDataRead and small AvgTokensAvg may be more likely to be in Cluster 6D, for example, given that their feature values lead to higher Shapley values and a higher likelihood of being in Cluster 6D using Delta-normalization. Cluster 6D has a relatively high variance and high probability of outliers.

The result of feature importance based on Shapley value and the Gini importance may be different. Shapley values may be consistent and accurate in terms of measuring feature contribution, although may be computationally expensive (e.g., time-consuming).

In some examples (e.g., for delta normalization), jobs with larger inputs and using fewer tokens may be more likely to have a large variation. A larger number of tokens may evacuate other jobs from the same machine, which may reduce interference and the impact of noisy neighbors.

Job characteristics (e.g., operator counts) may (e.g., significantly) impact a prediction. The existence of certain operators may be more likely to result in different runtime distributions. For example, a plot of operator counts for some types of operators or operations (e.g., index lookup count, window count, range count) versus Shapley values (e.g., for delta normalization) reveals that an increasing number of operator counts may increase runtime variation.

Ratio-normalization may be utilized. For example (e.g., using ratio normalization), cluster 0D has a smaller variance and smaller probability of outliers than cluster 2D, while both have two modes. A comparison of Shapley values for high-importance features may be performed for two clusters e.g., cluster 0D and cluster 2D). A job may be more likely to be classified/labeled as cluster 0D than cluster 2D by predictor(s) 134, for example, if the job has lower CPU utilization, standard deviation and low usage of spare tokens. As may be observed, cluster 0D may indicate more reliable performance compared to cluster 2D. Machines with high utilization levels or standard deviations may be expected to have less reliable performance. The usage of spare tokens (e.g., whose availability may be less predictable) may (e.g., also) lead to less stable runtimes. In some examples, lower CPU utilization (e.g., load), lower standard deviation, and/or less use of spare tokens may improve runtime reliability. Explainer 136 may quantitatively evaluate the resulting performance change based on cluster properties.

A Pearson correlation between Shapley values and feature values for the most important (e.g., top-10 important) features contributing (e.g., positively or negatively) to runtime variation may visualize relative contributions to prediction for one or more (e.g., all) cluster/classes (e.g., for ratio and delta normalization). The x-axis may show the index of the clusters and the y-axis may list the different features.

In an example (e.g., for delta normalization), a Pearson correlation may show that one or more feature values (e.g., TempDataReadAvg and TotalDataReadAvg) may have a high positive correlation with the Shapley value for clusters 6D and 7D while having a negative correlation with the Shapley value for clusters 0D and 1D. A job instance with a larger input size (e.g., and potentially a longer runtime) may increase the predicted likelihood of being in clusters 6D and 7D with more runtime variability (e.g., since Shapley values increase with a positive correlation with a feature value) and may decrease the predicted likelihood of being in clusters 0D and 1D.

In an example, (e.g., for ratio normalization), a Pearson-correlation may indicate that variance measured by the absolute difference between the runtime and the median is more sensitive to the size of the job. A Pearson correlation may show that one or more (e.g., many) operators have an (e.g., a significant) impact on a cluster (e.g., runtime distribution class) prediction and/or that one or more (e.g., many) operators (e.g., PhyOpRangeCount) may trend towards clusters 6R and 7R with higher values.

In some examples (e.g., for ratio normalization), a Pearson-correlation may indicate that increasing the vertex count on machines with faster CPUs and/or larger resource capacities may tend to shift the prediction to clusters 0R and 1R, indicating that running vertices on faster machine SKUs may decrease runtime variation.

Shapley values may indicate changes of a prediction score without (e.g., directly) indicating a final predicted cluster label. Further evaluation of the quantitative impact of a prediction change may be implemented, for example, by editor 138.

Editor 138 is configured to analyze alternative (e.g., hypothetical, what-if, potential or modified) scenarios, for example, to provide users and/or operators with options to reduce runtime variation. As shown in FIG. 3A, editor 138 may generate editor information, which may include, for example, possible changes to a proposed job, based on the runtime distribution prediction(s) generated by predictor(s) 134. Editor information may be provided from editor 138, for example, to job manager 106 (e.g., through prediction manager 126 as job analysis information) for presentation (e.g., display) to user(s) 102 on a GUI displayed by computing device(s) 104. A presentation may include, for example, displaying editor information described herein to user(s) 102 and/or to an operator (e.g., admin for a cloud computing service that executes jobs).

Editor 138 may propose hypothetical scenarios and/or may evaluate the potential improvement of runtime performance based on predictions by predictor(s) 134. User(s) 102 and/or operators may be presented (e.g., in job manager 106) with alternative (e.g., hypothetical, what-if, potential or modified) scenarios for prospective job execution. Potential opportunities to reduce variation in job execution may be identified, for example, by limiting reliance on spare (e.g., potentially unavailable) resources, scheduling on faster (e.g., newer generations of) machines, improving load balancing across machines, modifying an execution plan, etc.

Editor information (e.g., alone or in combination with predictions and explainer information) may support changes from the operations (e.g., job execution) side and/or the customer side (e.g., user(s) 102) to improve job performance. Editor 138 may utilize the prediction model (e.g., predictor(s) 134) to make predictions about hypothetical scenarios and report the results to user(s) 102 and/or operators for manual or automated decisions about proposed jobs and/or their execution.

In a (e.g., first) example scenario, editor 138 may modify a spare token allocation in a proposed job, predictor(s) 134 may generate one or more predicted runtime distribution classes/labels (e.g., cluster 0R-07 and/or 0D-7D) for the modified proposed job, which may be used by editor 138 to provide editor information about possible changes to reduce runtime variation.

As previously discussed, spare tokens may be additional resource tokens, e.g., beyond tokens/resources requested for a proposed/submitted job at submission time. Spare tokens may be dynamically allocated to jobs depending on token utilization and availability of resources in the cluster. Availability of spare tokens (e.g., shared resources) may depend on physical cluster conditions that are affected by the execution of other jobs, making spare tokens a source of variation. The model may be used to estimate the impact on runtime variation if spare tokens are not allocated.

Table 4 shows an example of reducing runtime variation (e.g., shifting predictions from cluster 2D to 1D) by reducing spare tokens.

TABLE 4
Example reducing runtime variation by reducing spare tokens

| Name | Value | | | | | |
|---|---|---|---|---|---|---|
| SpareTokensAvg | 0 | 2 | 4 | 6 | 8 | 10 |
| Prediction | Cluster 1D | Cluster2D | Cluster2D | Cluster 2D | Cluster2D | Cluster2D |

In an example, spare tokens may be disabled for all jobs in a test set (dataset D3 in Table 1). A prediction transition matrix may show changes in predictions from an originally predicted cluster to a newly predicted cluster based on the reduction of spare tokens. Each cell in the transition matrix may show (e.g., in percentages) jobs with a different prediction for the cluster label. In an example (e.g., for ratio normalization), 15% of jobs that were predicted in cluster 2R may be predicted to be cluster 1R. Reduction of spare tokens may reduce outlier probabilities, which may reduce the gap in runtimes between the 25^{th} and 75^{th} percentiles, and the 95^{th} percentile of the normalized runtime (e.g., as previously described in Table 3). The transition matrix may (e.g., also) show a significant change from predictions of cluster 3R to cluster 5R, for example, based on a decrease in the standard deviation (e.g., from 1.45 to 0.82). Other examples of changes in predictions based on reduction of spare tokens may include some predictions for test set jobs changing from clusters 3R, 4R, 5R and 6R to cluster 1R. In some examples, although the gap between 25 and 75^{th} percentile was reduced (e.g., by removing reliance on spare tokens), the probability of outliers increased, indicating a trade-off for some jobs between more stable performance in general and a higher probability of extreme slowdown based on some particular job characteristics captured in job features. Similar changes may be observed in a prediction transition matrix for delta normalization. In many cases, reducing or disabling reliance on spare tokens (e.g., shared resources) may reduce runtime variation.

In a (e.g., second) example scenario, editor 138 may modify resources indicated by a proposed job to faster (e.g., more modern) machines. Predictor(s) 134 may generate one or more predicted runtime distribution classes/labels (e.g., cluster 0R-07 and/or 0D-7D) for the modified proposed job, which may be used by editor 138 to provide editor information about possible changes to reduce runtime variation.

A job's vertices may be executed by multiple machines in a distributed manner. Different job instances within the same job group may be allocated to many different SKUs (e.g., with varying processing capabilities). The impact on runtime variation may be observed, for example, by changing jobs to execute more vertices on later (e.g., faster) generations of machines.

In an example, all the vertices (e.g., both fractions and count) may be shifted from an older (e.g., slower) generation of machines to a newer (e.g., faster) generation of machines for all jobs in a test set (dataset D3 in Table 1). A prediction transition matrix may show changes in predictions from an originally predicted cluster to a newly predicted cluster based on the shift in vertices to faster machines. Each cell in the transition matrix may show (e.g., in percentages) jobs with a different prediction for the cluster label. In an example, 20.95% of job predictions changed from cluster 2R to 0R, e.g., with a significant drop in the gap between 25^{th} and 75^{th} percentile. In examples for Delta-normalization, a significant number of predictions changed from cluster 1D to 0D, with a drop in the gap between 25^{th} and 75^{th} percentile from 11 seconds to 4 seconds. In many cases, running more vertices on later generation SKUs may reduce runtime variation.

A runtime variation prediction model may capture the compounding of changes due to workload re-balancing, such as changes of CPU utilization levels. A model may predict the utilization levels given different workload distributions to capture the dynamic impact on job runtime variation.

In a (e.g., third) example scenario, editor 138 may modify physical cluster conditions (e.g., workload balance across machines executing a job), which may be indicated by a job and/or may be controllable by an operator (e.g., automated or manual admin for a cloud computing service). Predictor(s) 134 may generate one or more predicted runtime distribution classes/labels (e.g., cluster 0R-07 and/or 0D-7D) for the modified physical cluster conditions, which may be used by editor 138 to provide editor information about possible changes to reduce runtime variation.

Physical cluster conditions, such as load differences across machines, may be a source of runtime variation. The impact of more uniformly distributed loads on runtime variation may be observed, for example, by changing physical cluster conditions for jobs and comparing predictions by predictor(s) 134 with and without the change.

In an example, the standard deviation of CPU utilization may be reduced to zero (0) (e.g., equal load on all machines and by time) for all jobs in a test set (dataset D3 in Table 1). A prediction transition matrix may show changes in predictions from an originally predicted cluster to a newly predicted cluster based on the change to equal loading of machines. Each cell in the transition matrix may show (e.g., in percentages) jobs with a different prediction for the cluster label if/when the standard deviation of CPU utilization is reduced to zero (0). For example (e.g., for ratio normalization), the largest change in predictions may be 29.78% of predictions changing from cluster 2R to cluster 0R, which may be accompanied by a reduction of outlier probability and a reduction in runtime variation measured by the difference between the 25^{th} and 75^{th} percentiles. Similar reductions in runtime variation may be observed for delta normalization. In many cases, improved physical cluster conditions, such as improved load balancing, may reduce runtime variation.

A framework is described herein for systematically characterizing, modeling, predicting, and explaining runtime variations. A (e.g., each) job may be associated with a (e.g., predefined, clustered) probability distribution. Probability distribution shapes may differ according to one or more of the following: intrinsic job characteristics, resource allocation; and/or cluster conditions at the time a job is submitted for compiling and execution. A clustering model and classification predictor may be used to infer the distribution category of a normalized runtime distribution with high accuracy (e.g., greater than 96% accuracy). An ML algorithm may be interpretable. Sources of variation may be identified, such as usage of spare tokens, skewed loads on computing nodes, fractions of vertices executed on different SKUs, etc. Potential improvements may be determined by adjusting one or more identified sources of variation, e.g., as control variables. The model may integrate or be used with separate models that capture the effects on system utilization with workload re-balancing to dynamically optimize the performance of individual jobs.

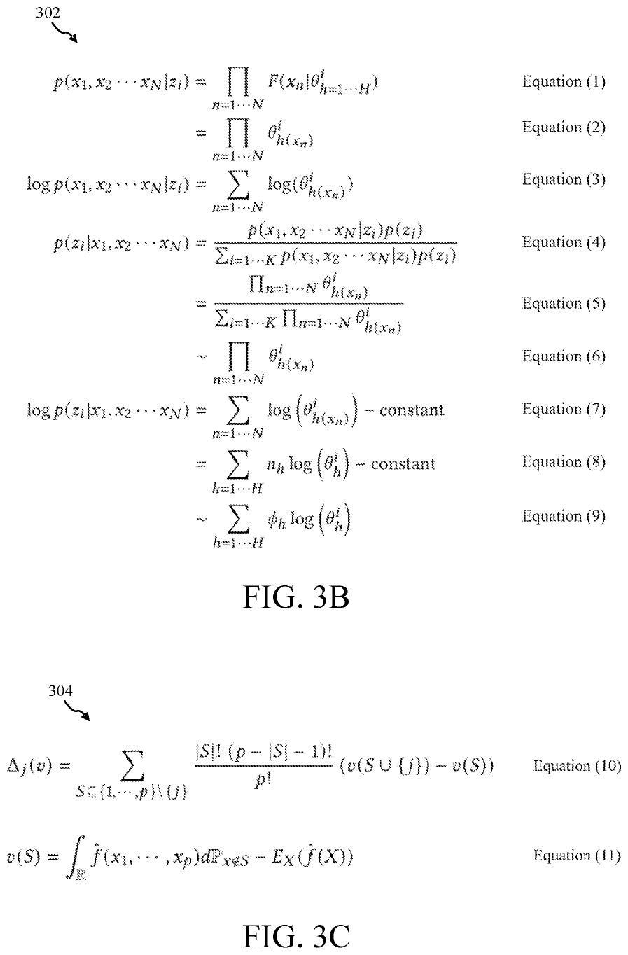

FIG. 4 shows a flowchart of a method 400 for predicting a runtime probability distribution for a proposed computing job, according to an example embodiment. Embodiments disclosed herein and other embodiments may operate in accordance with example method 400. Method 400 comprises steps 402-404. However, other embodiments may operate according to other methods. Other structural and operational embodiments will be apparent to persons skilled in the relevant art(s) based on the foregoing discussion of embodiments. No order of steps is required unless expressly indicated or inherently required. There is no requirement that a method embodiment implement all of the steps illustrated in FIG. 4. FIG. 4 is simply one of many possible embodiments. Embodiments may implement fewer, more or different steps.

As shown in FIG. 4, in step 402, a proposed computing job comprising a proposed execution plan and proposed computing resources to execute the proposed computing plan may be received. For example, as shown in FIG. 3A, the proposed job may be received by prediction manager 126 (e.g., from job manager 106 shown in FIG. 1). The proposed job may include indications of a proposed execution plan and proposed computing resources to execute the proposed plan.

As shown in FIG. 4, in step 404, a runtime probability distribution may be predicted for the proposed computing job based on the proposed execution plan and the proposed computing resources to execute the proposed computing plan. For example, as shown in FIGS. 1-3, predictor(s) 134 may predict one of clustered runtime probability distributions 0R-7R shown in FIG. 2A and/or one of clustered runtime probability distributions 0D-7D shown in FIG. 2B for the computing job received by prediction manager 126 based on the proposed execution plan and the proposed computing resources to execute the proposed plan.

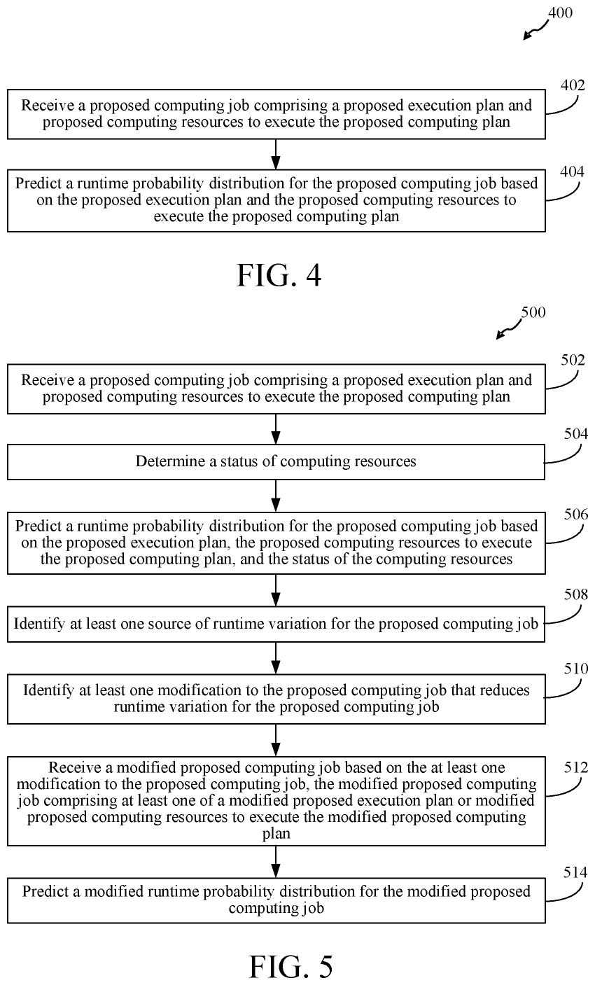

FIG. 5 shows a flowchart of a method 500 for predicting a runtime probability distribution, sources of runtime variation and proposed changes for a proposed computing job, according to an example embodiment. Embodiments disclosed herein and other embodiments may operate in accordance with example method 500. Method 500 comprises steps 502-514. However, other embodiments may operate according to other methods. Other structural and operational embodiments will be apparent to persons skilled in the relevant art(s) based on the foregoing discussion of embodiments. No order of steps is required unless expressly indicated or inherently required. There is no requirement that a method embodiment implements all of the steps illustrated in FIG. 5. FIG. 5 is simply one of many possible embodiments. Embodiments may implement fewer, more or different steps.

As shown in FIG. 5, in step 502, a proposed computing job comprising a proposed execution plan and proposed computing resources to execute the proposed computing plan may be received. For example, as shown in FIG. 3A, the proposed job may be received by prediction manager 126 (e.g., from job manager 106 shown in FIG. 1). The proposed job may include indications of a proposed execution plan and proposed computing resources to execute the proposed plan.

As shown in FIG. 5, in step 504, a status of computing resources may be determined. For example, as shown in FIG. 1, prediction manager 126 and/or featurizer 128 may access resource info 118 to determine the most recent information about the status of computing resources that may be used to execute the proposed job.

As shown in FIG. 5, in step 506, a runtime probability distribution may be predicted for the proposed computing job based on the proposed execution plan, the proposed computing resources to execute the proposed computing plan, and the status of the computing resources. For example, as shown in FIGS. 1-3, predictor(s) 134 may predict one of clustered runtime probability distributions 0R-7R shown in FIG. 2A and/or one of clustered runtime probability distributions 0D-7D shown in FIG. 2B for the computing job received by prediction manager 126 based on the proposed execution plan, the proposed computing resources to execute the proposed plan, and the status of computing resources that may be used to execute the proposed execution plan.

As shown in FIG. 5, in step 508, at least one source of runtime variation may be identified for the proposed computing job. For example, as shown in FIGS. 1 and 3, explainer 136 may determine explainer information, which may include one or more sources of runtime variation that led to the runtime distribution prediction(s) by predictor(s) 134.

As shown in FIG. 5, in step 510, identify at least one modification to the proposed computing job that reduces runtime variation for the proposed computing job. For example, as shown in FIGS. 1 and 3, editor 138 may determine editor information, which may include at least one possible change to the proposed job to reduce runtime variation.

As shown in FIG. 5, in step 512, a modified proposed computing job based on the at least one modification to proposed computing job may be received. The modified proposed computing job may comprise at least one of a modified proposed execution plan or modified proposed computing resources to execute the modified proposed computing plan. For example, as shown in FIGS. 1-3, editor 138 may provide to prediction manager 126 a modified proposed job. Prediction manager 126 may unilaterally provide the modified proposed job to featurizer 128 and/or to job manager 106 (e.g., for review and/or selection/approval by user(s) 102), which may send the modified proposed job to prediction manager 126. The modified proposed computing job may include at least one of a modified proposed execution plan or modified proposed computing resources.

As shown in FIG. 5, in step 514, predicting a modified runtime probability distribution may be predicted for the modified proposed computing job. For example, as shown in FIGS. 1-3, predictor(s) 134 may predict one of clustered runtime probability distributions 0R-7R shown in FIG. 2A and/or one of clustered runtime probability distributions 0D-7D shown in FIG. 2B for the modified computing job received by prediction manager 126. Explainer 136 may generate explainer information and editor 138 may generate editor information based on the prediction for the modified proposed computing job, which may be provided to job manager 106 (e.g., via prediction manager 126).

### III. Example Computing Device Embodiments

As noted herein, the embodiments described, along with any circuits, components and/or subcomponents thereof, as well as the flowcharts/flow diagrams described herein, including portions thereof, and/or other embodiments, may be implemented in hardware, or hardware with any combination of software and/or firmware, including being implemented as computer program code configured to be executed in one or more processors and stored in a computer readable storage medium, or being implemented as hardware logic/electrical circuitry, such as being implemented together in a system-on-chip (SoC), a field programmable gate array (FPGA), and/or an application specific integrated circuit (ASIC). A SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

FIG. 6 shows an exemplary implementation of a computing device 600 in which example embodiments may be implemented. Consistent with all other descriptions provided herein, the description of computing device 600 is a non-limiting example for purposes of illustration. Example embodiments may be implemented in other types of computer systems, as would be known to persons skilled in the relevant art(s).

As shown in FIG. 6, computing device 600 includes one or more processors, referred to as processor circuit 602, a system memory 604, and a bus 606 that couples various system components including system memory 604 to processor circuit 602. Processor circuit 602 is an electrical and/or optical circuit implemented in one or more physical hardware electrical circuit device elements and/or integrated circuit devices (semiconductor material chips or dies) as a central processing unit (CPU), a microcontroller, a microprocessor, and/or other physical hardware processor circuit. Processor circuit 602 may execute program code stored in a computer readable medium, such as program code of operating system 630, application programs 632, other programs 634, etc. Bus 606 represents one or more of any of several types of bus structures, including a memory bus or memory controller, a peripheral bus, an accelerated graphics port, and a processor or local bus using any of a variety of bus architectures. System memory 604 includes read only memory (ROM) 608 and random-access memory (RAM) 610. A basic input/output system 612 (BIOS) is stored in ROM 608.

Computing device 600 also has one or more of the following drives: a hard disk drive 614 for reading from and writing to a hard disk, a magnetic disk drive 616 for reading from or writing to a removable magnetic disk 618, and an optical disk drive 620 for reading from or writing to a removable optical disk 622 such as a CD ROM, DVD ROM, or other optical media. Hard disk drive 614, magnetic disk drive 616, and optical disk drive 620 are connected to bus 606 by a hard disk drive interface 624, a magnetic disk drive interface 626, and an optical drive interface 628, respectively. The drives and their associated computer-readable media provide nonvolatile storage of computer-readable instructions, data structures, program modules and other data for the computer. Although a hard disk, a removable magnetic disk and a removable optical disk are described, other types of hardware-based computer-readable storage media can be used to store data, such as flash memory cards, digital video disks, RAMs, ROMs, and other hardware storage media.

A number of program modules may be stored on the hard disk, magnetic disk, optical disk, ROM, or RAM. These programs include operating system 630, one or more application programs 632, other programs 634, and program data 636. Application programs 632 or other programs 634 may include, for example, computer program logic (e.g., computer program code or instructions) for implementing example embodiments described herein.

A user may enter commands and information into the computing device 600 through input devices such as keyboard 638 and pointing device 640. Other input devices (not shown) may include a microphone, joystick, game pad, satellite dish, scanner, a touch screen and/or touch pad, a voice recognition system to receive voice input, a gesture recognition system to receive gesture input, or the like. These and other input devices are often connected to processor circuit 602 through a serial port interface 642 that is coupled to bus 606, but may be connected by other interfaces, such as a parallel port, game port, or a universal serial bus (USB).

A display screen 644 is also connected to bus 606 via an interface, such as a video adapter 646. Display screen 644 may be external to, or incorporated in computing device 600. Display screen 644 may display information, as well as being a user interface for receiving user commands and/or other information (e.g., by touch, finger gestures, virtual keyboard, etc.). In addition to display screen 644, computing device 600 may include other peripheral output devices (not shown) such as speakers and printers.

Computing device 600 is connected to a network 648 (e.g., the Internet) through an adaptor or network interface 650, a modem 652, or other means for establishing communications over the network. Modem 652, which may be internal or external, may be connected to bus 606 via serial port interface 642, as shown in FIG. 6, or may be connected to bus 606 using another interface type, including a parallel interface.

As used herein, the terms “computer program medium,” “computer-readable medium,” and “computer-readable storage medium” are used to refer to physical hardware media such as the hard disk associated with hard disk drive 614, removable magnetic disk 618, removable optical disk 622, other physical hardware media such as RAMs, ROMs, flash memory cards, digital video disks, zip disks, MEMs, nanotechnology-based storage devices, and further types of physical/tangible hardware storage media. Such computer-readable storage media are distinguished from and non-overlapping with communication media (do not include communication media). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Example embodiments are also directed to such communication media that are separate and non-overlapping with embodiments directed to computer-readable storage media.

As noted above, computer programs and modules (including application programs 632 and other programs 634) may be stored on the hard disk, magnetic disk, optical disk, ROM, RAM, or other hardware storage medium. Such computer programs may also be received via network interface 650, serial port interface 642, or any other interface type. Such computer programs, when executed or loaded by an application, enable computing device 600 to implement features of example embodiments described herein. Accordingly, such computer programs represent controllers of the computing device 600.

Example embodiments are also directed to computer program products comprising computer code or instructions stored on any computer-readable medium. Such computer program products include hard disk drives, optical disk drives, memory device packages, portable memory sticks, memory cards, and other types of physical storage hardware.

### IV. Example Embodiments

Methods, systems and computer program products are provided for predicting runtime variation in bid data analytics. Runtime probability distributions may be predicted for proposed computing jobs. A predictor may classify proposed computing jobs based on multiple runtime probability distributions that represent multiple clusters of runtime probability distributions for multiple executed recurring computing job groups. Proposed computing jobs may be classified as delta-normalized runtime probability distributions and/or a ratio-normalized runtime probability distributions. Sources of runtime variation may be identified with a quantitative contribution to predicted runtime variation. A runtime probability distribution editor may indicate modifications to sources of runtime variation in a proposed computing job and/or predict reductions in predicted runtime variation provided by modifications to a proposed computing job.

In examples, a computing system may comprise one or more processors; and one or more memory devices that store program code configured to be executed by the one or more processors. The program code may comprise a runtime probability distribution predictor. The predictor may comprise a machine learning (ML) predictor configured to predict a runtime probability distribution for a proposed computing job, which may be used to generate additional information and/or for automated and/or manual decisions pertaining to the proposed computing job.

In examples, the runtime probability distribution may comprise a runtime probability distribution shape and parameters for the shape.

In examples, the runtime probability distribution shape may comprise a flexible distribution shape with tunable parameters for customized runtime probability distribution shapes.

In examples, the ML predictor may be configured to classify the proposed computing job as the runtime probability distribution from a plurality of runtime probability distributions representing a plurality of clusters of runtime probability distributions for a plurality of executed recurring computing job groups.

In examples, a first ML predictor may be configured to predict a delta-normalized runtime probability distribution for the proposed computing job from a plurality of delta-normalized runtime probability distributions representing a first plurality of clusters for delta-normalized runtime probability distributions for the executed recurring computing job groups. A second ML predictor may be configured to predict a ratio-normalized runtime probability distribution for the proposed computing job from a plurality of ratio-normalized runtime probability distributions representing a second plurality of clusters for ratio-normalized runtime probability distributions for the executed recurring computing job groups.

In examples, the ML predictor may be configured to classify the proposed computing job as the runtime probability distribution from a plurality of runtime probability distributions having at least one multi-mode runtime probability distribution.

In examples, a runtime probability distribution explainer may be configured to identify at least one source of runtime variation for the proposed computing job.

In examples, the at least one source of runtime variation may comprise a plurality of sources of runtime variation and a quantitative contribution for each of the plurality of sources of runtime variation to the predicted runtime probability distribution.

In examples, the program code may further comprise a runtime probability distribution editor configured to identify at least one modification to the proposed computing job that reduces runtime variation for the proposed computing job.

In examples, the runtime probability distribution editor may identify (e.g., based on the identified modification to the at least one source of runtime variation) a modification to the predicted runtime probability distribution or a different predicted runtime probability distribution.

In examples, the proposed computing job may indicate an execution plan and computing resources to execute the execution plan. The modification to the proposed computing job may comprise a modification to at least one of the proposed execution plans or the computing resources.

In examples, a method may comprise receiving a proposed computing job comprising a proposed execution plan and proposed computing resources to execute the proposed computing plan; and predicting, by a machine learning (ML) predictor, a runtime probability distribution for the proposed computing job based on the proposed execution plan and the proposed computing resources to execute the proposed computing plan.

In examples, a method may (e.g., further) comprise determining a status of computing resources. Predicting, by the machine learning (ML) predictor, may comprise predicting the runtime probability distribution for the proposed computing job based on the proposed execution plan, the proposed computing resources to execute the proposed computing plan, and the status of the computing resources.

In examples, a method may (e.g., further) comprise identifying at least one source of runtime variation for the proposed computing job.

In examples, the method may (e.g., further) comprise identifying at least one modification to the proposed computing job that reduces runtime variation for the proposed computing job.

In examples, a method may (e.g., further) comprise receiving a modified proposed computing job based on the at least one modification to the at least one source of runtime variation, the modified proposed computing job comprising at least one of a modified proposed execution plan or modified proposed computing resources to execute the modified proposed computing plan; and predicting a modified runtime probability distribution for the modified proposed computing job.

In examples, the ML predictor may be configured to classify the proposed computing job as the runtime probability distribution from a plurality of runtime probability distributions representing a plurality of clusters of runtime probability distributions for a plurality of executed recurring computing job groups.

In examples, a computer-readable storage medium may comprise program instructions recorded thereon that, when executed by a processing circuit, perform a method comprising: receiving a proposed computing job comprising a proposed execution plan and proposed computing resources to execute the proposed computing plan; determining a status of computing resources; and predicting, by a machine learning (ML) predictor, a runtime probability distribution for the proposed computing job based on the proposed execution plan, the proposed computing resources to execute the proposed computing plan, and the status of the computing resources.

In examples, a method may (e.g., further) comprise identifying at least one source of runtime variation for the proposed computing job.

In examples, a method may (e.g., further) comprise identifying at least one modification to the proposed computing job that reduces runtime variation for the proposed computing job.

### V. Conclusion

While various examples have been described above, it should be understood that they have been presented by way of example only, and not limitation. It will be understood by those skilled in the relevant art(s) that various changes in form and details may be made therein without departing from the spirit and scope of the present subject matter as defined in the appended claims. Accordingly, the breadth and scope of the present subject matter should not be limited by any of the above-described examples, but should be defined only in accordance with the following claims and their equivalents.

What is claimed is:

1. A computing system, comprising:
one or more processors; and
one or more memory devices that store program code configured to be executed by the one or more processors, the program code comprising:
a predictor configured to predict a runtime probability distribution for a proposed computing job.

2. The computing system of claim 1, wherein the runtime probability distribution comprises a runtime probability distribution shape and parameters for the shape.

3. The computing system of claim 2, wherein the runtime probability distribution shape comprises a flexible distribution shape with tunable parameters for customized runtime probability distribution shapes.

4. The computing system of claim 1, wherein the predictor is configured to classify the proposed computing job as the runtime probability distribution from a plurality of runtime probability distributions representing a plurality of clusters of runtime probability distributions for a plurality of executed recurring computing job groups.

5. The computing system of claim 4, wherein the predictor comprises
a first predictor configured to predict a delta-normalized runtime probability distribution for the proposed computing job from a plurality of delta-normalized runtime probability distributions representing a first plurality of clusters for delta-normalized runtime probability distributions for the executed recurring computing job groups; and
a second predictor configured to predict a ratio-normalized runtime probability distribution for the proposed computing job from a plurality of ratio-normalized runtime probability distributions representing a second plurality of clusters for ratio-normalized runtime probability distributions for the executed recurring computing job groups.

6. The computing system of claim 1, wherein the predictor is configured to classify the proposed computing job as the runtime probability distribution from a plurality of runtime probability distributions having at least one multi-mode runtime probability distribution.

7. The computing system of claim 1, further comprising:
an explainer configured to identify at least one source of runtime variation for the proposed computing job.

8. The computing system of claim 7, wherein the at least one source of runtime variation comprises a plurality of sources of runtime variation and a quantitative contribution for each of the plurality of sources of runtime variation to the predicted runtime probability distribution.

9. The computing system of claim 1, further comprising:
an editor configured to identify at least one modification to the proposed computing job that reduces runtime variation for the proposed computing job.

10. The computing system of claim 9, wherein the editor identifies, based on the identified modification to the proposed computing job, a modification to the predicted runtime probability distribution or a different predicted runtime probability distribution.

11. The computing system of claim 9, wherein the proposed computing job indicates an execution plan and computing resources to execute the execution plan, and wherein the modification to the proposed computing job comprises a modification to at least one of the proposed execution plans or the computing resources.

12. A method, comprising:
receiving a proposed computing job comprising a proposed execution plan and proposed computing resources to execute the proposed computing plan; and
predicting a runtime probability distribution for the proposed computing job based on the proposed execution plan and the proposed computing resources to execute the proposed computing plan.

13. The method of claim 12, further comprising:
determining a status of computing resources; and
wherein the predicting comprises predicting the runtime probability distribution for the proposed computing job based on the proposed execution plan, the proposed computing resources to execute the proposed computing plan, and the status of the computing resources.

14. The method of claim 12, further comprising:
identifying at least one source of runtime variation for the proposed computing job.

15. The method of claim 12, further comprising:
identifying at least one modification to the proposed computing job that reduces runtime variation for the proposed computing job.

16. The method of claim 14, further comprising:
receiving a modified proposed computing job based on the at least one modification to the proposed computing job, the modified proposed computing job comprising at least one of a modified proposed execution plan or modified proposed computing resources to execute the modified proposed computing plan; and
predicting a modified runtime probability distribution for the modified proposed computing job.

17. The method of 12, wherein the predicting classifies the proposed computing job as the runtime probability distribution from a plurality of runtime probability distributions representing a plurality of clusters of runtime probability distributions for a plurality of executed recurring computing job groups.

18. A computer-readable storage medium having program instructions recorded thereon that, when executed by a processing circuit, perform a method comprising:
receiving a proposed computing job comprising a proposed execution plan and proposed computing resources to execute the proposed computing plan;
determining a status of computing resources; and
predicting a runtime probability distribution for the proposed computing job based on the proposed execution plan, the proposed computing resources to execute the proposed computing plan, and the status of the computing resources.

19. The method of claim 18, further comprising:
identifying at least one source of runtime variation for the proposed computing job.

20. The method of claim 19, further comprising:
identifying at least one modification to the proposed computing job that reduces runtime variation for the proposed computing job.
